(19) United States
(12) Patent Application Publication
(10) Pub. No.: US 2011/0181476 A1
(43) Pub. Date: Jul. 28, 2011

(54) MINIATURE PATCH ANTENNA AND METHODS

(76) Inventors: Ari Raappana, Kello (FI); Petteri Annamaa, Oulunsalo (FI); Kimmo Koskiniemi, Oulu (FI)

(21) Appl. No.: 12/693,241

(22) Filed: Jan. 25, 2010

(51) Int. Cl. H01Q 9/04; H01Q 1/24; H01P 11/00

(52) U.S. Cl. 343/702; 343/700 MS; 29/601

(57) ABSTRACT

A miniature patch antenna element useful for wireless applications such as portable radio devices, and methods for using and manufacturing the same. In one embodiment, a plurality of discrete ceramic elements creates a spatially loaded miniature patch antenna. Ceramic material is placed only at locations where it achieves the desired effect on reducing the physical length of a half-wave radiator. In one variant, these locations comprise the edges of the half-wave radiator (e.g., metallic plate). This configuration advantageously has lower weight, smaller size and reduced cost that result from using less ceramic material in the construction of the antenna. Moreover, RF performance of the antenna is improved as compared to a fully ceramic construction, as electric field losses in the spatially loaded antenna structure are reduced as well.

### COPYRIGHT

A portion of the disclosure of this patent document contains material that is subject to copyright protection. The copyright owner has no objection to the facsimile reproduction by anyone of the patent document or the patent disclosure, as it appears in the Patent and Trademark Office patent files or records, but otherwise reserves all copyright rights whatsoever.

### FIELD OF THE INVENTION

The present invention relates generally to antennas for use in wireless or portable radio devices, and more particularly in one exemplary aspect to a spatially loaded miniature internal patch antenna, and methods of utilizing and manufacturing the same.

### DESCRIPTION OF RELATED TECHNOLOGY

Patch antennas, also referred to as micro strip patch antennas, are common in the art. An exemplary patch antenna 100 according to the prior art is shown in FIG. 1, and typically includes a transmission line feed 101, a homogeneous slab of dielectric 102 (such as ceramic), and a metalized patch 104 disposed on either the top plane or both the top and the bottom planes of the dielectric slab 102. Conventional patch antennas are directly coupled to the feed 101 by a coaxial cable 106, a connector 108, or soldered directly to the printed wired board (PWB) of the radio device.

The feed point to the top surface radiating element 104 is accomplished using a metallic pin 110 penetrating through the ceramic slab via a preformed non-metalized hole. Alternatively, the antenna feed can be arranged using two feeding strips 112 on two sides of the patch.

Typically, patch antennas utilize a solid slab of ceramic substrate, disposed over a ground plane, as a radiator. This configuration has several disadvantages, such as: use of expensive ceramic material, thereby resulting in higher cost, size and weight of the antenna component. Additionally due to a rather high relative permittivity ∈ᵣ and dielectric loss tangent tan δ of ceramic material (when compared to air) electrical field is attenuated by the solid ceramic substrate which degrades RF performance of the antenna, that is fabricated using a solid patch of ceramic.

The plane in which the electric field varies is also known as the polarization plane. A large number of applications, including satellite positioning and wireless communications require circular polarization antennas as the orientation of the transmitting and receiving antennas varies and is often unknown. Additionally, circular polarized antennas are used to suppress multipath reflections.

In a circularly polarized antenna, the electric field varies in two orthogonal planes (e.g., x and y directions) with the same magnitude, and a 90° phase difference. The result is the simultaneous excitation of two modes; i.e., the TM10 mode (mode in the x direction) and the TM01 (mode in the y direction). One of the modes is excited with a 90° phase delay with respect to the other mode. Therefore, two orthogonal resonances are created within a single patch antenna element by the feed point arrangement. Correct phase shifting between the feed points for two resonances creates a rotating circular polarization, thereby controlling left-hand and right-hand polarization dominance.

A circularly polarized antenna can either be right-hand circular polarized (RHCP) or left-hand circular polarized (LHCP). In a circularly-polarized antenna, the plane of polarization rotates in a “corkscrew” or helix pattern, making one complete revolution during each wavelength. A circularly polarized wave radiates energy in the horizontal and vertical planes, as well as every plane in between. If the rotation is clockwise (looking in the direction of propagation), the sense is referred to as right-hand-circular polarization (RHCP). If the rotation is counterclockwise, the sense is referred to as left-hand circular polarization (LHCP).

Circular polarization is well known in the art, and can be achieved by a number of ways: e.g., building a patch with two resonance frequencies in orthogonal directions, and using the antenna at an intermediate frequency that is between the two resonances. Alternatively, circular polarization is achieved by splitting the transmission signal in half, changing the phase of one of the signals by 90°, and feeding each signal to a separate resonator, wherein two resonators are arranged orthogonally with respect to each other. Signal splitting is accomplished in various ways including, inter alia, a Wilkinson power divider or a similar splitter, a parallel RLC resonant circuit, or other well known means not described further herein.

Typically, prior art patch antennas (such as that shown in FIG. 1) that are made from a single slab of ceramic with two electrodes on either side of the slab. These electrodes are linearly polarized, since the electric field only varies in one direction (orthogonal to the patch plane). This polarization can be either vertical or horizontal, depending on the orientation of the patch. A transmit antenna should have a receiving antenna with the same polarization for optimum operation. It would however be advantageous to have a circularly polarized patch antenna of the type generally referenced above for use in wireless devices, particularly for Global Positioning System (GPS) applications. Ideally, such a circularly polarized antenna would be cost-effective to manufacture, spatially compact, and light weight, while providing desirable electrical performance.

### SUMMARY OF THE INVENTION

The present invention satisfies the foregoing needs by providing, inter alia, a miniature patch antenna for use in mobile wireless devices.

In a first aspect of the invention, an antenna is disclosed. In one embodiment, the antenna comprises: first and second substantially planar plates, the first and second plates each being arranged substantially parallel to each other at a predetermined spacing; first and second resonators, each further comprising at least a pair of dielectric elements, each of the dielectric elements having a longitudinal dimension, a transverse dimension, and a vertical dimension, the resonators disposed substantially between the first and second plates; and a feed structure electrically coupled to the first and second metal plates. The dielectric elements are arranged substantially around a perimeter of the first and second metal plates.

In another embodiment, the antenna is for use in a mobile radio device, and comprises: first and second substantially planar metal plates, the first and second plates each having a longitudinal dimension and a transverse dimension and being arranged substantially parallel to each other at a predetermined spacing; first and second resonators, each further comprising a radiation axis, and at least a pair of dielectric elements, each of the dielectric elements having a longitudinal dimension, a transverse dimension, and a vertical dimension, the resonators disposed substantially between the first and second plates; and a feed structure electrically coupled to the first and second metal plates. The dielectric elements are arranged substantially around a perimeter of the first and second metal plates, the predetermined spacing is equal to or greater than the vertical dimension; and the resonators are configured to form an orthogonal pair.

In one variant, the antenna is configured for use within a global positioning system (GPS) receiver of the mobile radio device.

In another variant, the dielectric elements each comprise substantially rectangular ceramic blocks, and the feed structure comprises a discrete pin.

In another variant, the antenna further comprises phase shift apparatus, the phase shift apparatus configured to shift a first portion of an input signal in electrical phase (e.g., by 90 degrees) with respect to a second portion of the signal.

In a further variant, the antenna is configured for substantially circular polarization.

In another variant, the dielectric element comprises a substantially rectangular ceramic strip, disposed along the perimeter of the first and second metal plates.

In a further variant, electronics parts of the mobile radio device are disposed at least partly within the cavity formed by the ceramic blocks.

In a second aspect of the invention, a method of constructing a reduced-weight antenna is disclosed. In one embodiment, the antenna comprises first and second substantially planar electrodes, and the method comprises: disposing at least first and second pairs of dielectric elements on the first electrode and substantially around a perimeter thereof, the elements of the first and second pairs not touching one another; and disposing the second electrode proximate the first electrode and the dielectric elements such that the first and second electrodes are substantially parallel and aligned with one another, the dielectric elements and the first and second electrodes cooperating to form a cavity.

In one variant, the act of disposing comprises joining the first and second pairs of dielectric elements to the first electrode.

In another variant, the dielectric elements each comprise substantially rectangular ceramic blocks, and the act of disposing comprises disposing the elements such that the first pair of elements is substantially perpendicular to, yet coplanar with, the second pair of elements.

In yet another variant, the dielectric elements within the first pair form a first resonator, and the dielectric elements within the second pair form a second resonator, each of the first and second resonators having axes substantially coplanar with the first and second electrodes. For example, the first resonator may comprise a half-wave resonator.

In a further variant, the size of the mobile radio device is reduced by placing at least some of the electronics parts of the mobile radio device (to include all of them in some implementations) within the cavity formed by the ceramic blocks of the antenna.

In a third aspect of the invention, a method of operating an antenna is disclosed. In one embodiment, the antenna comprises first and second substantially planar electrodes, at least two substantially discrete dielectric elements, and a feed point, and the method comprises: inserting an input signal at the feed point; dividing the signal into first and second components; phase-shifting at least one of the first and second components with respect to the other of the components; and applying the first and second components to respective ones of the at least two substantially discrete dielectric elements so as to generate electromagnetic radiation.

In one variant, the at least two substantially discrete dielectric elements comprise four substantially discrete dielectric elements disposed in two pairs. For instance, the two pairs comprise a first pair having first and second substantially parallel dielectric elements and a second pair having first and second substantially parallel dielectric elements.

In another variant, the phase shifting comprises shifting at least one of the components 90-degrees with respect to the other, and the antenna is configured for substantially circular polarization.

In yet another variant, the act of applying the first and second components to respective ones of the at least two substantially discrete dielectric elements so as to generate electromagnetic radiation comprises generating energy in a defined band.

In another embodiment, the method comprises: receiving electromagnetic energy at the antenna via the at least two substantially discrete dielectric elements, the received electromagnetic energy comprising first and second substantially polarized components; phase-shifting at least one of the first and second components with respect to the other of the components so as to place the first and components substantially in the same phase; and collecting the first and second phase-aligned components from the antenna.

In one variant, the act of receiving the first and second components comprises receiving energy in a defined GPS (Global Positioning System) band.

In yet another embodiment, the antenna comprises first and second substantially planar electrodes, at least two resonator elements, and a feed point, and the method comprises: inserting an input signal at the feed point; dividing the signal into first and second components; phase-shifting at least one of the first and second components with respect to the other of the components; and applying the first and second components to respective ones of the at least two resonator elements so as to generate electromagnetic radiation.

In one, variant, at least one of the at least two resonator elements comprises a half-wave resonator.

In a fourth aspect of the invention, an antenna for use in a mobile radio device is disclosed. In one embodiment, the antenna comprises: a first substantially planar conductive plate, the first plate comprising a first dimension and a second dimension; a dielectric element having an outer perimeter, a third dimension, and an aperture formed therein, the dielectric element electrically coupled to the first plate and disposed substantially parallel to the first plate; and a feed structure electrically coupled to the first conductive plate. The first conductive plate, the feed structure and the dielectric element are configured to form at least two resonances.

In one variant, the first dimension comprises a longitudinal dimension, the second dimension comprises a transverse dimension, and the third dimension comprises a vertical dimension orthogonal to the longitudinal and transverse dimensions.

In a fifth aspect of the invention, a method of constructing a reduced-size mobile radio device is disclosed. The device comprising a printed circuit board (PCB) with associated electronic components, patch antenna, the antenna comprising a first substantially planar electrode, the method comprising: disposing a dielectric element having an outer perimeter, a vertical dimension, and an aperture formed therein, the dielectric element electrically coupled to the first electrode and disposed substantially parallel to the first electrode; disposing the patch antenna a predetermined distance from the PCB, so that the first electrode is substantially parallel to the PCB, and the dielectric element, the PCB and the first electrode cooperate to form a cavity; and placing the electronic components associated with the PCB substantially inside the cavity.

In a sixth aspect of the invention, a reduced-size mobile device is disclosed. In one embodiment, the device comprises: a printed circuit board (PCB) with associated electronic components; and an antenna, the antenna comprising: a first substantially planar electrode; and a dielectric element having an outer perimeter, a vertical dimension, and an aperture formed therein, the dielectric element electrically coupled to the first electrode and disposed substantially parallel thereto. The antenna is disposed a predetermined distance from the PCB so that the first electrode is substantially parallel to the PCB, and the dielectric element, the PCB and the first electrode cooperate to form a cavity; and the electronic components associated with the PCB reside substantially inside the cavity.

In one variant, the antenna comprises an antenna adapted for use with a global positioning system (GPS) receiver, and the mobile device is selected from the group consisting of: (i) a smartphone; and (ii) a laptop or handheld computer.

In another variant, the antenna comprises an antenna adapted for use with a global positioning system (GPS) receiver, and the mobile device comprises a cellular-enabled telephony device having a cellular wireless interface and at least one other wireless interface.

These and other embodiments, aspects, advantages, and features of the present invention will be set forth in part in the description which follows, and in part will become apparent to those skilled in the art by reference to the following description of the invention and referenced drawings or by practice of the invention.

### BRIEF DESCRIPTION OF THE DRAWINGS

The features, objectives, and advantages of the invention will become more apparent from the detailed description set forth below when taken in conjunction with the drawings, wherein:

FIG. 1 is an isometric view illustrating a fully ceramic patch antenna according to the prior art.

FIG. 2A is an isometric exploded view of an antenna configuration in accordance with one embodiment of the present invention.

FIG. 2B is a plan view depicting a half-wavelength resonator structure configuration in accordance with one embodiment of the invention.

FIG. 2C is a plan view depicting two orthogonal half-wavelength resonator structures configuration in accordance with one embodiment of the present invention.

FIG. 2D is an isometric view of dielectric element configuration in accordance with one embodiment of the present invention.

FIG. 2E is an isometric view of dielectric element configuration in accordance with another embodiment of the present invention.

FIG. 3 is a plan view depicting half-wavelength and a one-and-one-half wavelength resonator structures in accordance with an embodiment of the present invention.

FIG. 4A is a cross-sectional view depicting a spatially loaded antenna configuration in accordance with one alternative embodiment of the present invention.

FIG. 4B is a cross-sectional view depicting a spatially loaded antenna configuration in accordance with another alternative embodiment of the present invention.

FIG. 5A is a top plan view illustrating a plastic carrier element for use with a spatially loaded antenna in accordance with an embodiment of the present invention.

FIG. 5B is a top plan view of the metal radiator element for use with a spatially loaded antenna according to FIG. 5A.

FIG. 5C is a side view of the metal radiator element according to FIG. 5B with ceramic elements installed.

FIG. 6A is a top plan view of the antenna configuration illustrating a spatially loaded antenna configuration comprising a plastic carrier element in accordance with an embodiment of the present invention.

FIG. 6B is a cross-sectional view of the device of FIG. 6A, taken along line 6D-6D.

FIG. 6C is a top plan view illustrating a ceramic element strip, formed around the perimeter of the antenna, in accordance with one alternative embodiment of the present invention.

FIG. 6D is a side view of yet another embodiment of the invention, illustrating a spatially loaded antenna configuration comprising electronic components disposed within the antenna cavity.

FIG. 6E is a cross-sectional view of a spatially loaded antenna device in accordance with still another embodiment of the present invention, configured similar to the embodiment of the antenna 600 described above with respect to FIG. 6A.

FIG. 7A is a plot showing measured free space input return loss as a function of frequency for: (i) one exemplary embodiment of the antenna configuration in accordance with the principles of the present invention, and (ii) a reference monolithic ceramic patch antenna.

FIG. 7B is a plot depicting a free-space measured efficiency as a function of frequency for: (i) one exemplary embodiment of the antenna configuration in accordance with the principles of the present invention; and (ii) a reference monolithic ceramic patch antenna.

FIG. 8A is a plot illustrating measured maximum 3D gain as a function of frequency for: (i) one exemplary embodiment of the antenna configuration in accordance with the principles of the present invention; and (ii) a reference monolithic ceramic patch antenna.

FIG. 8B is a plot showing measured left hand circular polarization (LHCP) gain as a function of frequency for: (i) one exemplary embodiment of the antenna configuration in accordance with the principles of the present invention; and (ii) a reference monolithic ceramic patch antenna.

FIG. 8C is a plot showing measured right hand circular polarization (RHCP) gain for: (i) one exemplary embodiment of the antenna configuration in accordance with the principles of the present invention; and (ii) a reference monolithic ceramic patch antenna.

FIG. 9 is a plot showing measured axial ratio at zenith as a function of frequency for: (i) one exemplary embodiment of the antenna configuration in accordance with the principles of the present invention; and (ii) a reference monolithic ceramic patch antenna.

All Figures disclosed herein are © Copyright 2009 Pulse Engineering, Inc. All rights reserved.

### DETAILED DESCRIPTION OF THE PREFERRED EMBODIMENT

Reference is now made to the drawings wherein like numerals refer to like parts throughout.

As used herein, the terms “antenna,” “antenna system,” and “multi-band antenna” refer without limitation to any system that incorporates a single element, multiple elements, or one or more arrays of elements that receive/transmit and/or propagate one or more frequency bands of electromagnetic radiation. The radiation may be of numerous types, e.g., microwave, millimeter wave, radio frequency, digital modulated, analog, analog/digital encoded, digitally encoded millimeter wave energy, or the like. The energy may be transmitted from location to another location, using, or more repeater links, and one or more locations may be mobile, stationary, or fixed to a location on earth such as a base station.

As used herein, the terms “board” and “substrate” refer generally and without limitation to any substantially planar or curved surface or component upon which other components can be disposed. For example, a substrate may comprise a single or multi-layered printed circuit board (e.g., FR4), a semi-conductive die or wafer, or even a surface of a housing or other device component, and may be substantially rigid or alternatively at least somewhat flexible.

The terms “communication systems” and communication devices” refer without limitation to any services, methods, or devices that utilize wireless technology to communicate information, data, media, codes, encoded data, or the like from one location to another location.

As used herein, the terms “electrical component” and “electronic component” are used interchangeably and refer to components adapted to provide some electrical function, including without limitation inductive reactors (“choke coils”), transformers, filters, gapped core toroids, inductors, capacitors, resistors, operational amplifiers, and diodes, whether discrete components or integrated circuits, whether alone or in combination.

The terms “feed,” “RF feed,” “feed conductor,” and “feed network” refer without limitation to any energy conductor and coupling element(s) that can transfer energy, transform impedance, enhance performance characteristics, and conform impedance properties between an incoming/outgoing RF energy signals to that of one or more connective elements, such as for example a radiator.

The terms “frequency range”, “frequency band”, and “frequency domain” refer to without limitation any frequency range for communicating signals. Such signals may be communicated pursuant to one or more standards or wireless air interfaces

As used herein, the terms “global positioning system” or “GPS” refer without limitation to any global navigation satellite system or “GNSS”, such as United States NAVSTAR GPS, European Galileo system, and Russian global navigation satellite system or “GLONASS” or variants of thereof including without limitation assisted GPS or “A-GPS”, differential GPS or “DGPS”, enhanced GPS or “EGPS”, or “E-GPS”, the quasi-zenith satellite system or “QZSS”, satellite based augmentation system or “SBAS”, European geostationary navigation overlay service or “EGNOS”, wide area augmentation service or “WAAS”, StarFire® navigation system, Starfix® DGPS System, OmniSTAR® system, multi-functional satellite augmentation system or “MSAS, GPS aided geo augmentation navigation or “GAGAN” system, and other similar navigation systems, as well as any combinations thereof.

As used herein, the term “integrated circuit” or “IC)” refers to any type of device having any level of integration (including without limitation ULSI, VLSI, and LSI) and irrespective of process or base materials (including, without limitation Si, SiGe, CMOS and GaAs). ICs may include, for example, memory devices (e.g., DRAM, SRAM, DDRAM, EEPROM/Flash, and ROM), digital processors, SoC devices, FPGAs, ASICs, ADCs, DACs, transceivers, memory controllers, and other devices, as well as any combinations thereof.

As used herein, the term “memory” includes any type of integrated circuit or other storage device adapted for storing digital data including, without limitation, ROM. PROM, EEPROM, DRAM, SDRAM, DDR/2 SDRAM, EDO/FPMS, RLDRAM, SRAM, “flash” memory (e.g., NAND/NOR), and PSRAM.

As used herein, the terms “microprocessor” and “digital processor” are meant generally to include all types of digital processing devices including, without limitation, digital signal processors (DSPs), reduced instruction set computers (RISC), general-purpose (CISC) processors, microprocessors, gate arrays (e.g., FPGAs), PLDs, reconfigurable compute fabrics (RCFs), array processors, and application-specific integrated circuits (ASICs). Such digital processors may be contained on a single unitary IC die, or distributed across multiple components.

As used herein, the terms “mobile device”, “mobile radio device” “client device”, “peripheral device” and “end user device” include, but are not limited to, handheld Global Positioning System (GPS) devices, portable GPS, GPS-enabled mobile personal communication devices, personal computers (PCs) and minicomputers, whether desktop, laptop, or otherwise, set-top boxes, personal digital assistants (PDAs), personal integrated communication or entertainment devices, or literally any other device capable of receiving signals via a radio link from or another device.

As used herein, the terms “radiator,” “radiating plane,” and “radiating element” refer without limitation to an element that can function as part of a system that receives and/or transmits radio-frequency electromagnetic radiation; e.g., an antenna.

As used herein, the term “signal conditioning” or “conditioning” shall be understood to include, but not be limited to, signal voltage transformation, filtering and noise mitigation, signal splitting, impedance control and correction, current limiting, capacitance control, and/or time delay.

As used herein, the terms “top”, “bottom”, “side”, “up”, “down” and the like merely connote a relative position or geometry of one component to another, and in no way connote an absolute frame of reference or any required orientation. For example, a “top” portion of a component may actually reside below a “bottom” portion when the component is mounted to another device (e.g., to the underside of a printed circuit board (PCB)).

As used herein, the term “Wi-Fi” refers to, without limitation, any of the variants of IEEE-Std. 802.11 or related standards including 802.11 a/b/g/n.

As used herein, the term “wireless” means any wireless signal, data, communication, or other interface including without limitation Wi-Fi, Bluetooth, 3G (e.g., 3GPP, 3GPP2, and UMTS), HSDPA/HSUPA, TDMA, CDMA (e.g., IS-95A, WCDMA, etc.), FHSS, DSSS, GSM, PAN/802.15, WiMAX (802.16), 802.20, narrowband/FDMA, OFDM, PCS/DCS, Long Term Evolution (LTE) or LTE-Advanced (LTE-A), analog cellular, CDPD, satellite systems (including GPS), millimeter wave or microwave systems, optical, acoustic, and infrared (i.e., IrDA).

### Overview

The present invention provides, in one salient aspect, a miniature patch antenna apparatus for use in a wireless device (such as a mobile radio or cellular device), and methods for manufacturing and utilizing the same. In one embodiment, the antenna apparatus comprises two half-wave resonator elements disposed orthogonally with respect to each other. The resonator elements are sandwiched between two metallic plates, thereby forming a radiator patch. Each half-wave resonator comprises a pair of discrete ceramic dielectric elements that are spaced at a half-wavelength apart. The signals that drive the two resonators are formed in one variant with a 90-degree phase shift, therefore creating a circularly polarized transmit antenna. Left or right hand polarization is controlled by the placement of the antenna feed point, which determines the phase sift between the two antenna elements. In a receive mode, the foregoing elements act as a receive antenna.

The antenna apparatus further optionally comprises an adhesive layer on the bottom portion for easy placement within the radio device enclosure.

In another exemplary embodiment, the antenna comprises a half-wave resonator, and a one-and-one-half-wave resonator, each oriented orthogonally with respect to the other.

Methods for reducing the size, weight and/or cost of a patch antenna (such as for use in a mobile radio device) is also disclosed. In one embodiment, the method comprises using discrete ceramic elements in place of a solid ceramic patch to form a spatially loaded patch antenna. In one variant, these discrete ceramic elements are placed between two rectangular-shaped metallic plates around the perimeter of these plates. The placement locations are precisely selected to achieve the highest antenna gain and efficiency, and to reduce dielectric losses. By using discrete ceramic elements, the total volume of ceramic dielectric used for fabricating the antenna is advantageously reduced. This produces a more compact, light weight, and lower cost antenna apparatus that also has high level of RF performance due to, inter alia, smaller signal loss. Further size reduction of the mobile radio device is achieved by placing some or all of the electronic components of the device within the antenna cavity.

### DETAILED DESCRIPTION OF EXEMPLARY EMBODIMENTS

Detailed descriptions of the various embodiments and variants of the apparatus and methods of the invention are now provided. While primarily discussed in the context of a Global Positioning System (GPS) application, the apparatus and methodologies discussed herein are not so limited. In fact, many aspects of the invention described herein are useful in the operation and/or manufacture of any number of complex antennas, including, inter alia, devices that utilize WLAN (e.g., Wi-Fi), WMAN (e.g., WiMAX), Bluetooth, and other wireless communications technologies.

### Exemplary Antenna Apparatus

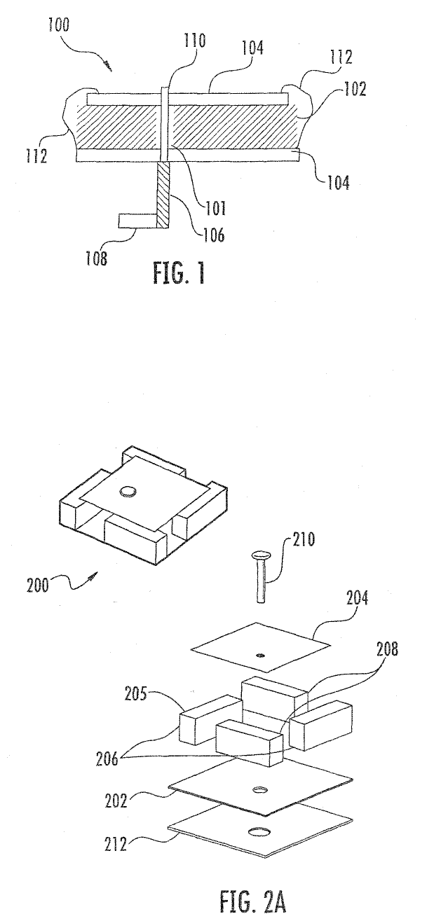

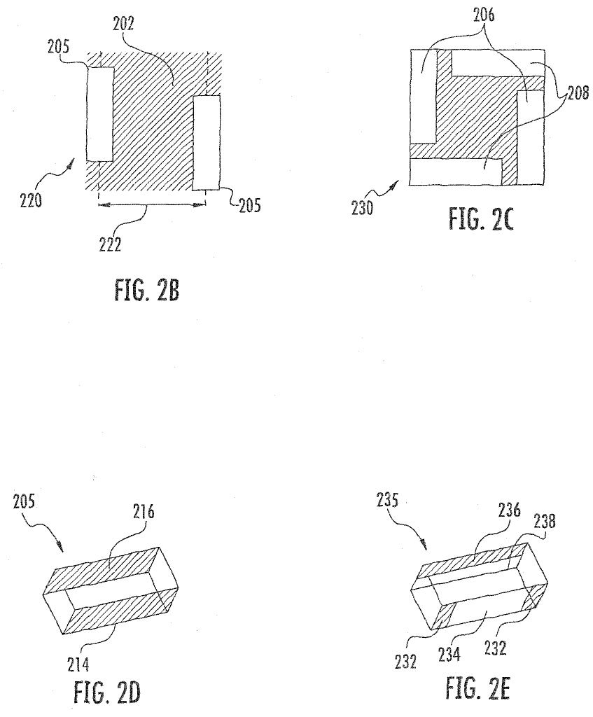

Referring now to FIGS. 2A-10, exemplary embodiments of the spatially loaded patch miniature antenna of the invention, and details regarding its performance, are described in detail.

It will be appreciated that while exemplary embodiments of the antenna of the invention are implemented using ceramic technology (due to its desirable attributes and performance), the invention is in no way limited to ceramic-based configurations, and in fact can be implemented using other technologies and materials, such as ceramic and plastic composites that have sufficient relative permittivity.

Also, while illustrated and described in the context of a circularly polarized antenna, it will be appreciated that the apparatus and methodologies of the invention are not so limited, and may in fact encompass other polarization schemes, including right hand and left hand elliptical polarization.

FIG. 2A illustrates one embodiment of a miniature patch antenna in accordance with the principles of the present invention. In this embodiment, the antenna 200 comprises two rectangular or square sheet metal plates (the base 202 and the top 204), and four rectangular substrate elements 205 sandwiched between the metal plates 202, 204 as shown. The substrate elements 205 are in this embodiment made from a ceramic material with relative permittivity of 82, although it will be appreciated that other materials may be used consistent with the invention as noted above. The value of relative permittivity affects the dielectric loading of the resonance frequencies, and thus has direct relation to size of the antenna structure.

These elements 205 are arranged in pairs to form resonators 206, 208, wherein opposing elements within each pair are parallel to each other, and the resonators 206, 208 are oriented orthogonally with respect to each other. The elements 205 are further arranged such that a gap 214 is formed between any two adjacent orthogonal elements as shown in FIG. 2A. A metal center pin 210 is installed to serve as a feed conductor.

In one exemplary embodiment, the antenna assembly 200 is coupled to the receive/transmit circuitry of a mobile radio device by a coaxial cable. In other embodiments, the antenna is coupled via an electrical radio frequency (RF) connector, or is soldered directly to a printed wired board (PWB) of the radio device.

The antenna assembly 200 may further comprise an optional adhesive layer 212 attached to bottom metal plate for mounting the antenna 200 within a host device (e.g., mobile radio device enclosure), although other attachment schemes may be used as well.

The sheet metal plates 202, 204 are fabricated from any common electrically conductive material used in antenna manufacture. These materials include, but are not limited to, aluminum, tin, copper, or tin bronze alloy such as CuSn₆. To further reduce cost, the plates 202, 204 can be manufactured using copper, bronze, tin or aluminum base with silver or copper plating. An organic solderability preservative (OSP) can be further added as required. Alternatively, the top and bottom metal plates can be also fowled by using a metalized dielectric substrate, such as printed circuit board (PCB) laminates, low temperature co-fired ceramics, or glass, etc. The antenna feed pin 210 is typically fabricated from copper alloy, or copper plated tin, although other materials may be used as well. Alternatively, the antenna feed comprises an integral part of the top metal plate.

In one variant, the lower and the upper electrodes 202, 204 are fabricated from a 0.15 mm thick sheet of metal. The lower electrode comprises an 18 mm×18 mm rectangle, while the upper electrode comprises a 13.6 mm×13.6 mm rectangle.

The pin 210 comprises a solderable copper, or tin bronze material (such as CuSn₆) with a diameter between about 0.5 mm and 1.0 mm. The adhesive element 212 is a 17.4 mm×17.4 mm rectangular, 0.2 mm thick piece made from any appropriate adhesive material such as 3M 468 VHB.

Conventionally, (ceramic) patch antennas have been constructed using a single monolithic ceramic body; i.e., a ceramic portion comprising a solid ceramic slab, wherein the high permittivity ceramic material is used to reduce the lateral dimensions that are required to create half-wave resonance on the surface of the substrate. From an electromagnetic (EM) field theory point of view, the “loading effect” of ceramic material is not completely homogeneous over the entire physical structure. Thus, a high permittivity material is needed only on certain areas in order to achieve the desired patch antenna performance. One spatial loading technique comprises placing the high permittivity material (e.g., ceramic) only into those areas where it is required for RF performance. Using smaller discrete ceramic blocks allows for a substantially miniaturized antenna design that reduces both antenna weight and cost, and volume occupied by the ceramic elements. However, the overall dimensions of the antenna (antenna outline or form factor) that are determined by the half-wave resonator requirements, are not reduced.

While regular patch antennas are formed by filling the entire antenna volume with the dielectric block (ceramic), spatially-loaded antenna element is realized using separate discrete dielectric blocks which create spatially-distributed electrical load at the frequency of interest. This spatially loaded configuration reduces antenna weight and allows for component placement (LNA, radio, etc.) within the antenna cavity.

According to one embodiment of the present invention, spatial dielectric loading is created by using four (4) discrete ceramic elements. Therefore, the ceramic material is placed only where it achieves the largest effect on reducing the physical length of the half-wave resonator. These locations are in one embodiment disposed at the edges of the half-wave radiating metallic plate. Two ceramic parts 205 are required to form the resonance, one at each end of the half-wave resonator 202 (see FIG. 2B). Two resonator pairs arranged orthogonally with respect to each other are shown in FIG. 2C. Each resonator 206, 208 comprises a pair of ceramic elements 205 placed on the opposing edges of the half-wavelength resonator, as described above with respect to FIG. 2B.

The two orthogonal resonator s 206, 208 form a spatially loaded patch antenna. To produce a circularly polarized antenna, the feed location is selected to provide an adequate phase shift between the two resonances, which are formed in each of the resonators 206, 208, such that the combination of these resonances creates circularly polarized antenna radiation characteristics.

Separate resonances are achieved in a patch antenna by: (i) splitting the feed signal that is delivered to the antenna apparatus from external radio device electronics into two equal parts (S1 and S2); (ii) creating a 90° phase shift between the signals S1, S2, by either delaying the S1 with respect to S2 by 90°, or delaying the S2 with respect to S1 by 90°; and (iii) feeding signal S1 to one of the resonators (e.g., 206) while feeding signal S2 to the other resonator (e.g., 208).

The four dielectric blocks 205 are fabricated from a ceramic material with relative permittivity of about 82. Other materials can be used, with the relative permittivity being different than that previously mentioned as applicable. In one variant, the top and the bottom sides of each block 205 comprise a metallization layer 214,216, as shown in FIG. 2D. In another variant (shown in FIG. 2E), the top side comprises a metalized portion 236 and a metal-free portion 238, while the bottom side 234 comprises two soldering pads 232 formed by metal deposition. Silver or any other conductive material can be used for metalized portions of the blocks 205. The metal-free portions are typically laser-formed, although other fabrication processes, such as etching, etc., are possible.

A metallic radiator is formed using the sheet metal plates 202, 204. A reflector (bottom surface metallization) is formed similarly as in the aforementioned radiator; i.e., using a sheet metal plates 202, 204. Both sheet metal plates 202, 204 are soldered onto the metallization layer 214, 216 that is deposited on the ceramic element 205 top/bottom surfaces as shown in FIG. 2D. The radiator feed arrangement is accomplished using the metal pin 210 in a similar fashion to that utilized in fully ceramic patch antennas. Electrically, the spatially loaded structure is similar to a fully ceramic structure, yet with the aforementioned advantages regarding spatial conservation, cost, and weight.

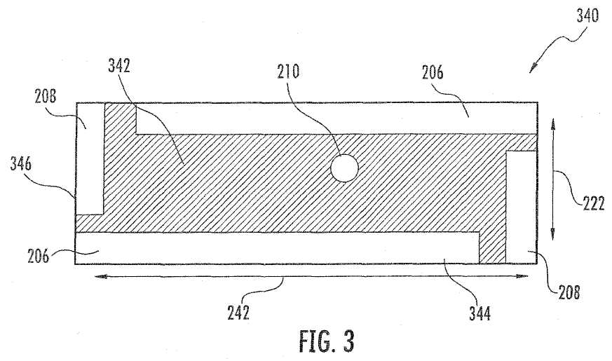

The ceramic elements 205 as shown in FIG. 2C comprise elements of the same physical size. As will be appreciated by those skilled in the art when given the present disclosure, myriad of alternative configurations are possible. For example, in one such variant, an antenna configuration featuring ceramic element pairs of different longitudinal dimensions is used. FIG. 3 shows a top plan view of one such rectangular patch antenna 240. The antenna 240 comprises a rectangular base and top planes, and the base plane 242 is shown comprising a longitudinal dimension 244 that is longer than the transverse dimension 246. Two pairs of ceramic elements 208, 206 form two resonators as described above with reference to FIG. 2C. However, in the embodiment of FIG. 3, the resonator 208 is formed at 3/2 wavelength (instead of the half-wavelength as described above in reference to FIGS. 2B and 2C).

It will be appreciated that while exemplary embodiments of the antenna of the invention illustrated above feature four equally sized ceramic elements, the invention is in no way limited to ceramic element configurations of the same size. In one variant, a spatially loaded antenna element is realized using ceramic elements that all have different size, relative permittivity, metallization, and placement with the antenna structure. In another variant, at least two (but not all) of the elements have common configurations/properties. In yet another variant, an antenna with fewer than four elements is realized by placing two dielectric elements substantially at one end of the L/2 resonator.

### Alternative Exemplary Antenna Apparatus

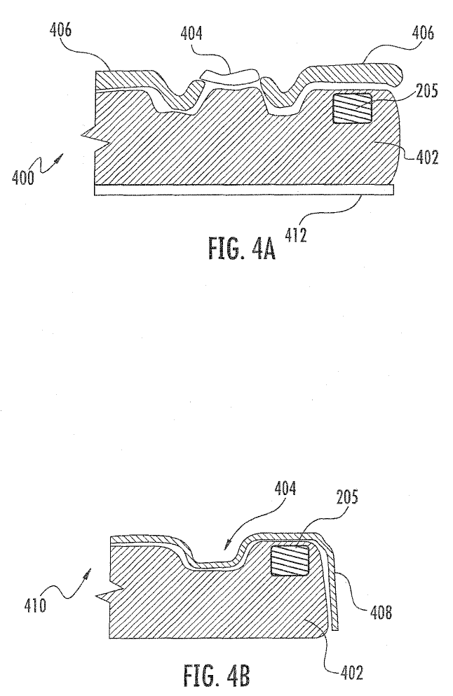

FIGS. 4A-6 herein present other exemplary embodiments of the spatially loaded patch antenna of the invention, comprising a plastic carrier. FIG. 4A shows an antenna apparatus 400, comprising a plastic carrier 402, sheet metal elements 406, flex patch 412 further comprising adhesive on both sides, and conductive strip lines.

These components allow the patch 412 to act as the bottom radiator element, as well as to provide adhesion functions. A dialectic element 205, fabricated from a material with high relative permittivity ∈ᵣ (such as ceramic), is placed at predetermined locations proximate to the metal strip.

The plastic carrier 402 and the sheet metal elements 406 are affixed by a heat joint 404, wherein the joint 404 stays below the surface level of the metal sheet. Hence, the joint does not increase the overall height of the antenna structure.

In another embodiment depicted in FIG. 4B, the sheet metal element 406 further comprises a feeding pad 408 that is configured to provide electric feed to the top radiator element of the antenna 410.

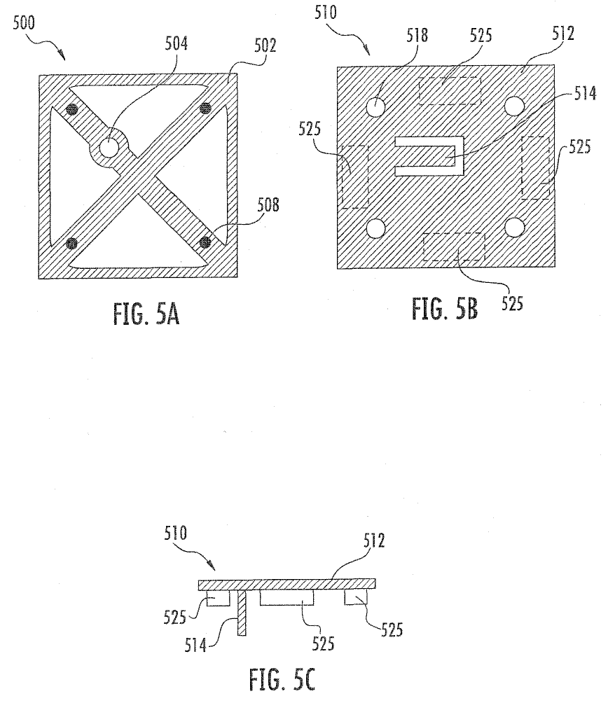

FIGS. 5A-5B depict yet another variant of a spatially loaded patch antenna apparatus 500 according to the invention. In this variant, the apparatus comprise a plastic carrier element 502 configured provide support for other antenna elements. FIG. 5A details the top side of the plastic carrier 502, which comprises an opening 504 for the feed pin (not shown), and four plastic studs 508 configured to provide structural support and antenna attachment to a PCB (not shown). FIG. 5B shows the top radiator 510, comprising four holes 518 configured to accept studs 508, and a rectangular sheet metal element 512, with the feed structure 514, that is formed as a ‘finger-shaped’ slot in the center of the metal plate 512. The dielectric elements 525 are disposed on the bottom side of the metal sheet around the perimeter of the radiator 510

FIG. 5C shows the side-view of the top radiator 510 with the feed pin 514 bent orthogonally to the plane of the radiator 512.

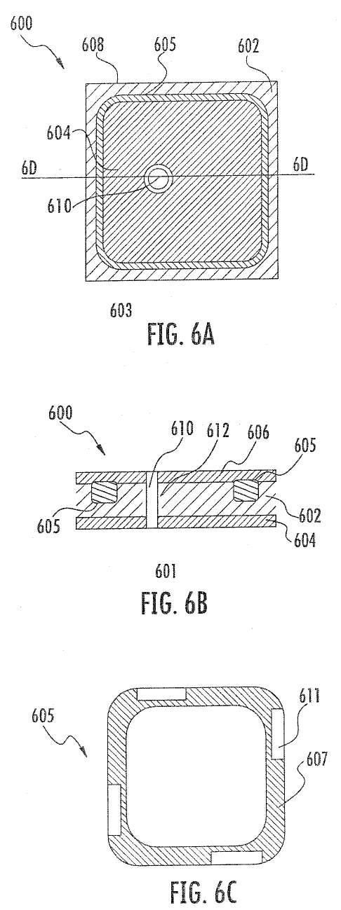

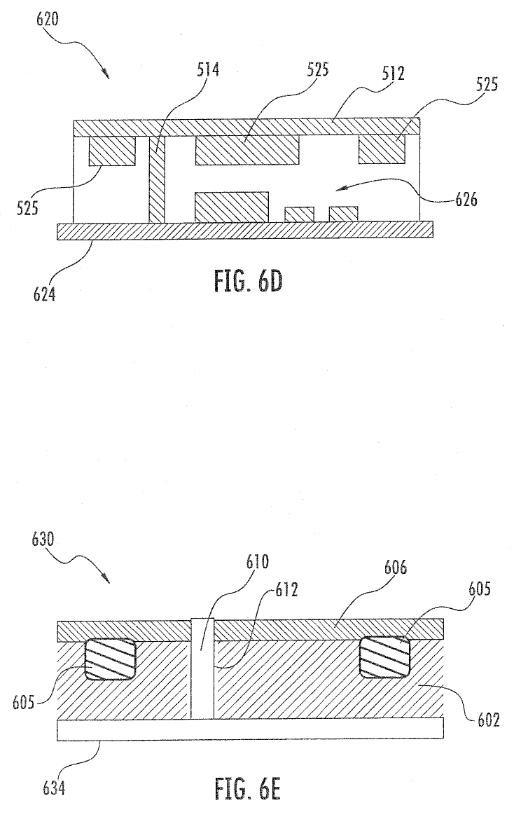

A further embodiment of the spatially loaded antenna apparatus in accordance with the principles of the present invention is represented FIGS. 6A-6C. The top view 603, shown in FIG. 6A, reveals the structure of the top sheet metal plate 604 and the antenna feed 610.

FIG. 6B shows a cross section view 601 of the antenna 600, taken along line 6D-6D, that comprises a plastic carrier element 602 sandwiched between two sheet metal plates 604 and 606, which form the bottom and the top radiator elements respectively. The feed pin 610 is routed through an opening 612 that is prefabricated in the plastic element 602.

A single square-shape strip of dielectric element 605 is attached to the bottom side of the top sheet metal plate. Electric field of half-wave resonators is the strongest proximate the open ends of the radiator. In the case of patch antenna these open ends are on the edges of the radiator surface area. The element 605 is, therefore, formed to follow the outer perimeter of the antenna where the antenna eclectic field is the strongest.

Referring now to FIG. 6C a top view of the patch element 605 is shown in detail. The patch 605 is fabricated from a dielectric material 607 with high ∈ᵣ values (such as ceramic). The element 605 further comprises several metalized portions 611 disposed on its top side for electrical connection to the top radiator plate 606.

FIG. 6D shows a side-view of antenna configuration 620 in accordance with another embodiment of the present invention. The antenna 620 is configured generally similar to the antenna embodiment 510 described above with respect to FIG. 5C, yet is disposed above a printed circuit board 624. The use of PCB substrate allows for straightforward integration of other functions and components 626 of a mobile radio device, such as RF filters, low noise amplifier (LNA) and associated RF-matching/biasing circuits, inside the antenna assembly.

Referring now to FIG. 6E, a cross-sectional view of yet another embodiment of the antenna apparatus 630, configured similar to the embodiment of the antenna 600 described above with respect to FIG. 6A, taken along line 6D-6D. However, the antenna 630 of FIG. 6E further comprises a double-side adhesive flex patch 634 that comprises conductive strip lines, allowing the patch 634 to act as the bottom radiator element as well as to provide adhesion functions.

### Antenna Performance

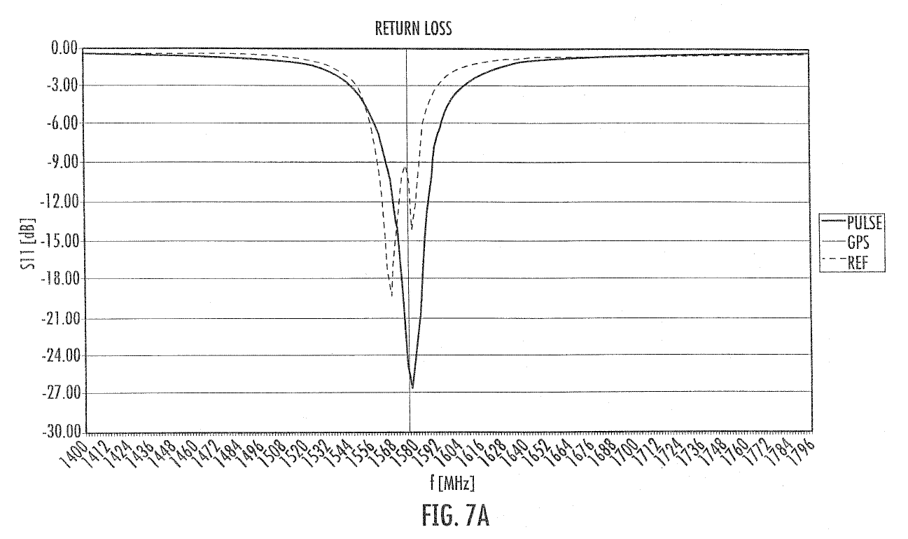

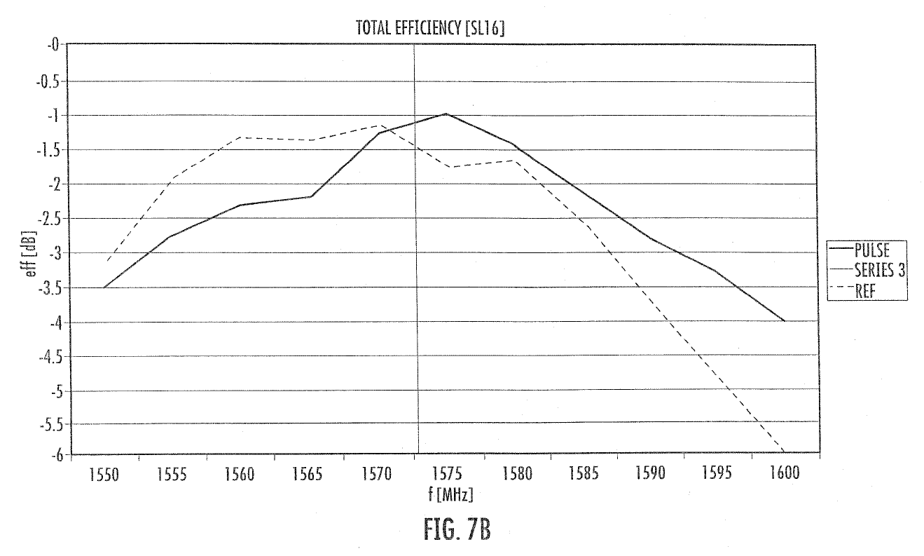

Referring now to FIGS. 7A-9, the performance of an exemplary Spatially Loaded Miniature Patch Antenna (SLMPA) in accordance with the principles of present invention is now described in detail.

Specifically, the performance of the SLMPA of FIG. 2A is compared to a ceramic antenna having the same outside dimensions of 18 mm×18 mm×4 mm. However, as the SLMPA utilizes smaller ceramic blocks (10 mm×3.2 mm), it comprises 512 mm³ of volume for its spatial loaded structure, as compared to 1296 mm³ for a fully ceramic prior art structure, thereby advantageously providing a 250% improvement in spatial utilization over the prior art.

FIG. 7A presents measured free-space return loss S11 (in dB) as a function of frequency for the SLMPA of the invention (solid curve) versus a reference antenna (here, manufactured by Cirocomm Corporation; gray curve). The vertical black line of FIG. 7A marks the GPS L1 frequency of 1575.42 MHz. The S11 parameter represents in effect how much power is reflected from the antenna. If S11=0 dB, then all the power is reflected from the antenna, and nothing is radiated. If S11=−10 dB, this implies that if 3 dB of power is delivered to the antenna, −7 dB is the reflected power.

FIG. 7A shows that the SLMPA design of the exemplary embodiment of the invention advantageously achieves about −25 dB of return loss at the GPS L1 frequency.

Referring now to FIG. 7B, data regarding measured free-space efficiency for the same antenna configurations as described above with respect to FIG. 7A is presented. The antenna efficiency (in dB) is defined as decimal logarithm of a ratio of radiated and input power:

$$AntennaEfficiency = 10 {log}_{10} ( \frac{Radiated Power}{Input Power} ) \qquad Eqn . ( 1 )$$

An efficiency of zero dB corresponds to an ideal theoretical radiator, wherein all of the input power is radiated. The data in FIG. 7B shows that the SLMPA of the invention achieves better total efficiency by about 0.5 dB when compared to the conventional fully ceramic patch. This represents 12% of additional power that is radiated by SLMPA antenna compared to the prior art design. This increased efficiency can have profound implications for, inter alia, mobile device with finite power sources (e.g., batteries), since less electrical power is required to produce the same radiated output energy.

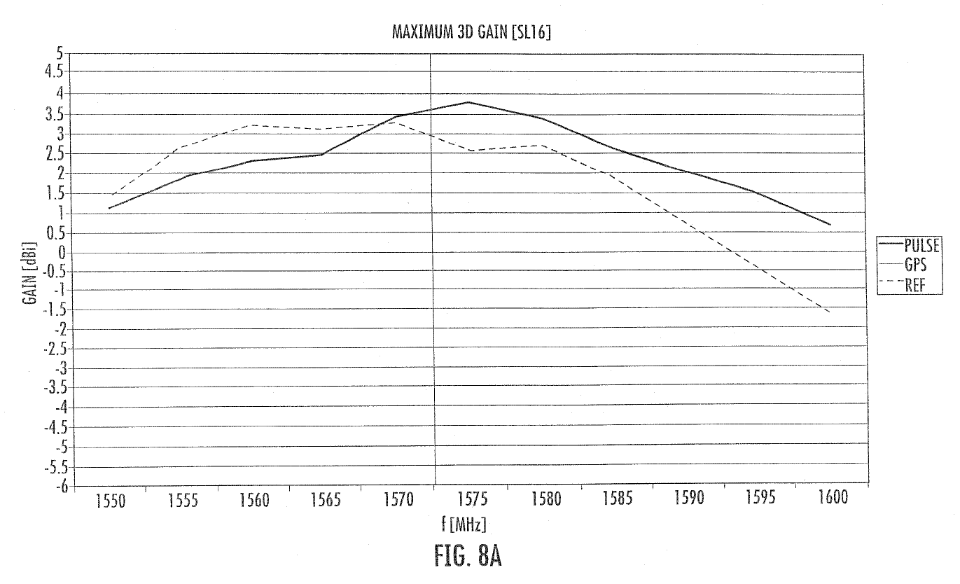

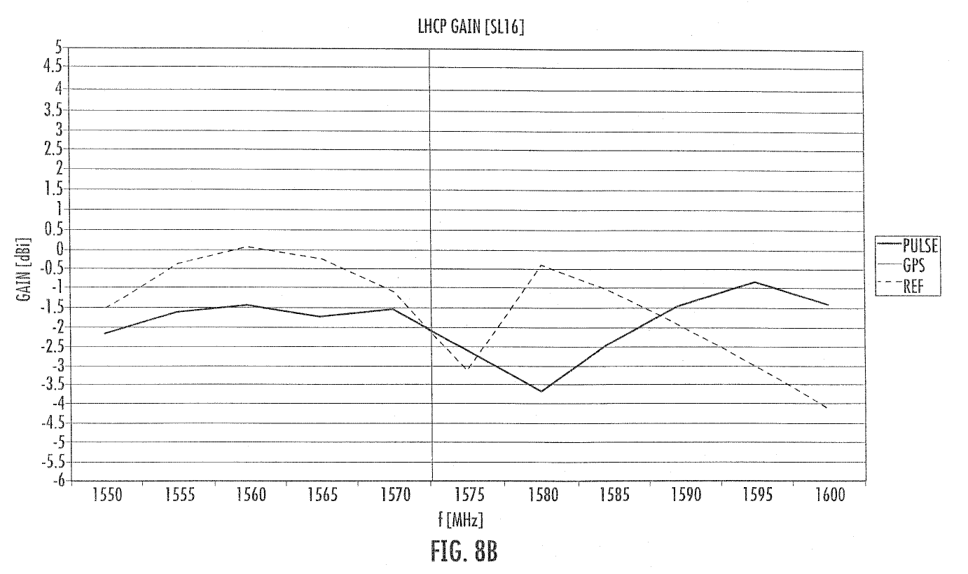

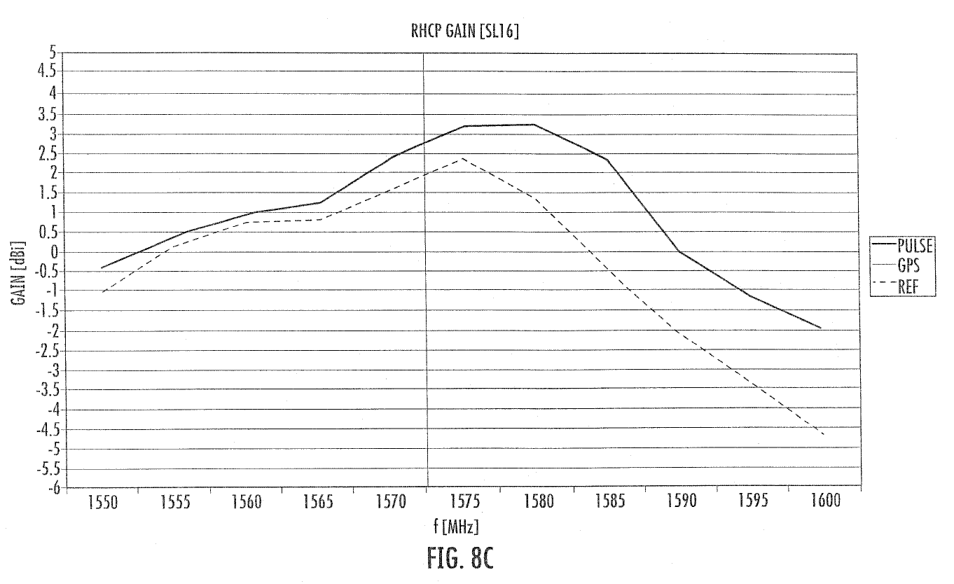

Referring now to FIGS. 8A-8C, antenna gain is analyzed and described in detail. FIG. 8A shows measured maximum 3-D gain, for the same antenna configurations as described above with respect to FIG. 7A. Antenna gain (in dB) is defined as a logarithm of a ratio of radiated intensity and input power:

$$Gain = 10 {log}_{10} ( 4 π \frac{Radiation Intensity}{Input Power} ) \qquad Eqn . ( 2 )$$

The data shown in FIG. 8A illustrates that the SLMPA of the present invention advantageously achieves higher maximum gain by about 0.8 dB when compared to the conventional patch antenna design.

Measured left-hand circular polarization (LHCP) antenna gain (in dB) as a function of frequency is presented in FIG. 8B, for the same antenna configurations as described above with respect to FIG. 8A.

FIG. 8C shows measured right-hand circular polarization (RHCP) antenna gain (in dB) as a function of frequency for the same antenna configurations as described above with respect to FIG. 8A.

The data presented in FIGS. 8B-8C demonstrates that both the reference and the SLMPA antenna of the present invention produce similar LHCP gains at the GPS L1 frequency (FIG. 8B), while the SLMPA delivers about 0.8 dB of additional RHCP gain (FIG. 8C) when compared to a fully ceramic reference patch antenna design.

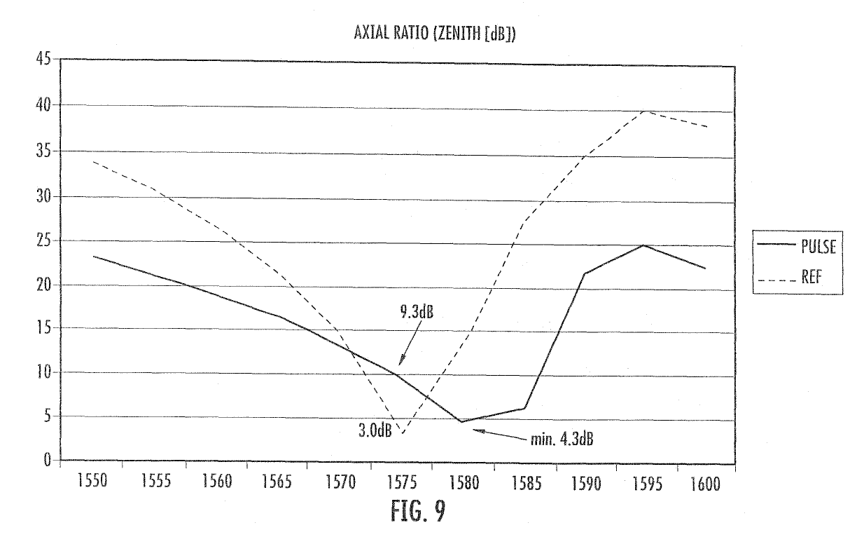

Referring now to FIG. 9, measured axial ratio as a function of frequency is presented for the same antenna configurations as described above with respect to FIG. 7A. The axial ratio is defined as a ratio of two orthogonal components of an E-field: a circularly polarized field is made up of two orthogonal E-field components of equal amplitude (and 90-degrees out of phase). Typically conventional patch antennas have somewhat elliptical polarization and axial ratio below 3 dB is acceptable.

The patch antenna configurations described herein offers several advantages over the prior art, including inter alia, lower weight and cost of the part, because less ceramic material (by about 2.5 times) is used in the construction. In addition, RF performance of the antenna is improved as compared to the fully ceramic construction, as the losses in the antenna structure are reduced as well. Specifically the data described above show that the SLMPA achieves wider impedance bandwidth, and 0.5-1 dB higher gain, than a reference (i.e., fully ceramic) patch antenna of the type described with respect to FIG. 1.

It will be recognized that while certain aspects of the invention are described in terms of a specific sequence of steps of a method, these descriptions are only illustrative of the broader methods of the invention, and may be modified as required by the particular application. Specifically, the use of smaller ceramic parts further reduces antenna weight and size. To further reduce antenna size and achieve additional antenna miniaturization, the feeding pin fabricated from the sheet metal radiator can be used as well. Certain steps may be rendered unnecessary or optional under certain circumstances. Additionally, certain steps or functionality may be added to the disclosed embodiments, or the order of performance of two or more steps permuted. All such variations are considered to be encompassed within the invention disclosed and claimed herein.

While the above detailed description has shown, described, and pointed out novel features of the invention as applied to various embodiments, it will be understood that various omissions, substitutions, and changes in the form and details of the device or process illustrated may be made by those skilled in the art without departing from the invention. The foregoing description is of the best mode presently contemplated of carrying out the invention. This description is in no way meant to be limiting, but rather should be taken as illustrative of the general principles of the invention. The scope of the invention should be determined with reference to the claims.

What is claimed is:

1. A patch antenna for use in a mobile radio device, said antenna comprising:
first and second substantially planar conductive plates, said first and second conductive plates each having a longitudinal dimension and a transverse dimension and being arranged substantially parallel to each other at a predetermined spacing;
first and second resonators, each further comprising a radiation axis, and at least a pair of dielectric elements, each of said dielectric elements having a longitudinal dimension, a transverse dimension, and a vertical dimension, said resonators disposed substantially between said first and second plates; and
a feed structure electrically coupled to said first and second conductive plates;
wherein said dielectric elements are arranged substantially around a perimeter of said first and second conductive plates; and
wherein said resonators are configured to form an orthogonal pair.

2. The patch antenna of claim 1, wherein said antenna is configured for use within a global positioning system (GPS) receiver of said mobile radio device.

3. The patch antenna of claim 1, wherein said dielectric elements each comprise substantially rectangular ceramic blocks.

4. The patch antenna of claim 3, wherein said transverse dimension of said dielectric elements is less that of said transverse dimension of said first and second conductive plates.

5. The patch antenna of claim 1, wherein said feed structure comprises a discrete pin.

6. The patch antenna of claim 1, further comprising phase shift apparatus, said phase shift apparatus configured to shift a first portion of an input signal in electrical phase with respect to a second portion of said signal.

7. The patch antenna of claim 6, wherein said phase shift comprises 90-degrees.

8. The patch antenna of claim 1, wherein said antenna is configured for substantially circular polarization.

9. The patch antenna of claim 1, wherein said first and second conductive plates comprise a rectangle.

10. The patch antenna of claim 1, wherein said predetermined spacing is equal to or greater than said vertical dimension;

11. A method of constructing a reduced-weight patch antenna, said antenna comprising first and second substantially planar electrodes, said method comprising:
arranging said first and said second electrodes substantially parallel to and spaced from each other; and
disposing at least first and second resonators between said first and second electrodes so that axes of both of said resonators are substantially perpendicular to each other, yet coplanar with both said first and said second electrodes;
wherein said dielectric elements are arranged substantially around a perimeter of said first and said second electrodes, so that to form a cavity in cooperation with said first and second electrodes.

12. A method of constructing a reduced-weight patch antenna, said antenna comprising first and second substantially planar electrodes, said method comprising:
disposing at least first and second pairs of dielectric elements on said first electrode and substantially around a perimeter thereof, said elements of said first and second pairs not touching one another; and
disposing said second electrode proximate said first electrode and said dielectric elements such that said first and second electrodes are substantially parallel and aligned with one another, said dielectric elements and said first and second electrodes cooperating to form a cavity.

13. The method of claim 12, wherein said act of disposing comprises joining said first and second pairs of dielectric elements to said first electrode.

14. The method of claim 12, wherein said dielectric elements each comprise substantially rectangular ceramic blocks, and said act of disposing comprises disposing said elements such that the first pair of elements is substantially perpendicular to, yet coplanar with, the second pair of elements.

15. The method of claim 12, wherein said dielectric elements within said first pair form a first resonator, and said dielectric elements within said second pair form a second resonator, each of said first and second resonators having an axes substantially coplanar with said first and second electrodes.

16. The method of claim 15, wherein said first resonator comprises a half-wave resonator.

17. A method of operating an antenna, said antenna comprising first and second substantially planar electrodes, at least two substantially discrete dielectric elements, and a feed point, the method comprising:
inserting an input signal at said feed point;
dividing said signal into first and second components;
phase-shifting at least one of the first and second components with respect to the other of said components; and
applying said first and second components to respective ones of said at least two substantially discrete dielectric elements so as to generate electromagnetic radiation.

18. The method of claim 17, wherein said at least two substantially discrete dielectric elements comprise four substantially discrete dielectric elements disposed in two pairs.

19. The method of claim 18, wherein said two pairs comprise a first pair having first and second substantially parallel dielectric elements, and a second pair having first and second substantially parallel dielectric elements.

20. The method of claim 19, wherein said act of phase shifting comprises shifting at least one of said components 90-degrees with respect to the other, and said antenna is configured for substantially circular polarization.

21. The method of claim 17, wherein said act of applying said first and second components to respective ones of said at least two substantially discrete dielectric elements so as to generate electromagnetic radiation comprises generating energy in a defined band.

22. A method of operating an antenna, said antenna comprising first and second substantially planar electrodes, at least two substantially discrete dielectric elements, and a feed point, the method comprising:
receiving electromagnetic energy at said antenna via said at least two substantially discrete dielectric elements, said received electromagnetic energy comprising first and second substantially polarized components;
phase-shifting at least one of the first and second components with respect to the other of said components so as to place said first and components substantially in the same phase; and
collecting said first and second phase-aligned components from the antenna.

23. The method of claim 22, wherein said act of receiving said first and second components comprises receiving energy in a defined GPS (Global Positioning System) band.

24. A method of operating an antenna, said antenna comprising first and second substantially planar electrodes, at least two resonator elements, and a feed point, the method comprising:
inserting an input signal at said feed point;
dividing said signal into first and second components;
phase-shifting at least one of the first and second components with respect to the other of said components; and
applying said first and second components to respective ones of said at least two resonator elements so as to generate electromagnetic radiation.

25. The method of claim 24, wherein at least one of said at least two resonator elements comprises a half-wave resonator.

26. An antenna for use in a mobile radio device, said antenna comprising:
a first substantially planar conductive plate, said first plate comprising a first dimension and a second dimension;
a dielectric element having an outer perimeter, a third dimension, and an aperture formed therein, said dielectric element electrically coupled to said first plate and disposed substantially parallel to said first plate; and
a feed structure electrically coupled to said first conductive plate;
wherein said first conductive plate, said feed structure and said dielectric element are configured to form at least two resonances.

27. The antenna of claim 26, wherein said first dimension comprises a longitudinal dimension, said second dimension comprises a transverse dimension, and said third dimension comprises a vertical dimension orthogonal to said longitudinal and transverse dimensions.

28. A method of constructing a reduced-size mobile radio device, said device comprising a printed circuit board (PCB) with associated electronic components, and an antenna, said antenna comprising a first substantially planar electrode, said method comprising:
disposing a dielectric element having an outer perimeter, a vertical dimension, and an aperture formed therein, said dielectric element electrically coupled to said first electrode and disposed substantially parallel to said first electrode;
disposing said antenna a distance from said PCB, so that said, first electrode is substantially parallel to said PCB, and said dielectric element, said PCB and said first electrode cooperate to form a cavity; and
placing said electronic components associated with said PCB substantially inside said cavity.

29. A reduced-size mobile device, said device comprising:
a printed circuit board (PCB) with associated electronic components; and
an antenna, said antenna comprising:
a first substantially planar electrode; and
a dielectric element having an outer perimeter, a vertical dimension, and an aperture formed therein, said dielectric element electrically coupled to said first electrode and disposed substantially parallel thereto;
wherein said antenna is disposed a predetermined distance from said PCB so that said first electrode is substantially parallel to said PCB, and said dielectric element, said PCB and said first electrode cooperate to form a cavity; and
wherein said electronic components associated with said PCB reside substantially inside said cavity.

30. The mobile device of claim 29, wherein said antenna comprises an antenna adapted for use with a global positioning system (GPS) receiver, and said mobile device is selected from the group consisting of: (i) a smartphone; and (ii) a laptop or handheld computer.

31. The mobile device of claim 29, wherein said antenna comprises an antenna adapted for use with a global positioning system (GPS) receiver, and said mobile device comprises a cellular-enabled telephony device having a cellular wireless interface and at least one other wireless interface.
